(19) United States
(12) Patent Application Publication
(10) Pub. No.: US 2018/0197115 A1
(43) Pub. Date: Jul. 12, 2018

(54) TENNIS, SQUASH AND RACQUETBALL COURTS RESERVATION SYSTEM

(71) Applicant: Ravi Shankar, Alexandria, VA (US)

(72) Inventor: Ravi Shankar, Alexandria, VA (US)

(21) Appl. No.: 15/403,659

(22) Filed: Jan. 11, 2017

(51) Int. Cl. G06Q 10/02; G06Q 30/06

(52) U.S. Cl. CPC G06Q 10/02; G06Q 30/0601

(57) ABSTRACT

A reservation system for tennis, squash and racquetball courts and a computer-implemented method for implementing the reservation system for tennis, squash and racquetball courts comprises a memory unit and a processor. The database stores one or more records associated with at least one tennis, squash and racquetball courts, and a set of program modules. The processor executes the set of program modules. The set of program modules comprises a display module, an input module and a booking module. The display module presents the user with the list of available time slots. The input module to receive a request from a user. The request is to reserve at least one of a tennis lesson and a tennis, squash and racquetball courts, in at least one available time slot in the list of available time slots. The booking module is configured to record the request in the database.

### BACKGROUND OF THE INVENTION

### A. Technical Field

The present invention generally relates to the technical field of computer networks, and more specifically relates to computer based tennis, squash and racquetball courts reservation system.

### B. Description of Related Art

Computers have pervaded every aspect of life. Users use computers for a plurality of purposes including accessing social media mobile applications. Examples of social media mobile applications include but are not limited to RepairPal, uber, Facebook, LinkedIn, meetup, and tumblr. Today, users access social media mobile applications for multiple purposes. As often is the case, users access social media mobile applications to acquire information about nearby restaurants, lodges, electronics showrooms and car repair centers. Further, users access social media mobile applications to identify locations of tennis, squash and racquetball courts in proximity of the users. However, existing systems lack a feature of enabling the users to reserve a tennis, squash and racquetball courts for personal use.

Therefore, there is a need in the art for a computer based tennis, squash and racquetball courts reservation system.

### SUMMARY OF THE INVENTION

The present invention relates to a reservation system for tennis, squash and racquetball courts and computer implemented method of implementing said reservation system.

In one embodiment of the present invention, a reservation system for tennis, squash and racquetball courts and a computer-implemented method for implementing the reservation system comprises a memory unit and a processor. The memory unit stores one or more records associated with at least one tennis, squash and racquetball courts, and a set of program modules. The one or more records comprise information regarding the location of at least one tennis, squash and racquetball courts, time and date of bookings, a list of available time slots and tennis lessons conducted on the tennis, squash and racquetball courts. The processor executes the set of program modules. The set of program modules comprises a display module, an input module and a booking module. The display module presents the user with the list of available time slots. The input module receives a request from a user. The request is to reserve at least one of a tennis lesson and or a tennis, squash and racquetball courts, in at least one available time slot from the list of available time slots. The booking module thereby records the request in the database. The set of program modules further comprises a purchaser module, executed by the processor, configured to enable the user to purchase one or more club memberships for the at least one tennis, squash and racquetball courts.

In one embodiment, the one or more records further comprises a list of tennis players using at least one tennis, squash and racquetball courts. Further, the input module receives the request via at least one of a user terminal and a telephone. Further, the display module presents the list of available time slots via at least one of an LED screen and a user terminal. Moreover, the user terminal is at least one of a smartphone, a laptop, and a personal computer. Furthermore, the input module receives the request as at least one of a voice command, a text command and a gesture based command. The display module further presents the user with the list of tennis players using at least one tennis, squash and racquetball courts. The set of program modules are implemented in a network of Application Specific Integrated Circuit (ASIC) Chipsets in the system.

In one embodiment of the present invention, a computer implemented method of implementing a reservation system for tennis, squash and racquetball courts comprises storing one or more records associated with at least one tennis, squash and racquetball courts, the one or more records comprise information regarding the location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts. The method further comprises presenting by a processor, via a display module the user with the list of available time slots. The method further comprises receiving by the processor, via an input module, a request from a user, wherein the request is to reserve at least one of a tennis lesson and a tennis, squash and racquetball courts, in at least one available time slot among the list of available time slots. The method further comprises recording by the processor, via a booking module, the request in the database. The method further comprises enabling the user by the processor via a purchaser module, to purchase one or more club memberships for the at least one tennis, squash and racquetball courts.

### BRIEF DESCRIPTION OF DRAWINGS

FIG. 1 is a block diagram of an environment implemented in accordance with one embodiment of the present invention.

FIG. 2 is flow chart of a computer-implemented method of implementing a reservation system for tennis, squash and racquetball courts, according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

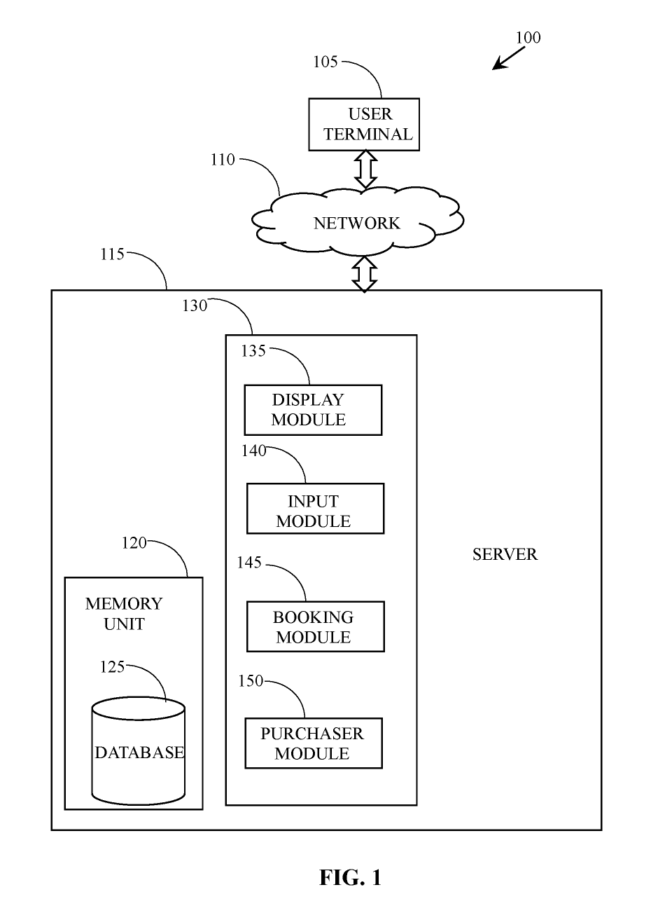

FIG. 1 is a block diagram of an environment 100 in accordance with one embodiment of the present invention. The environment 100 comprises a user terminal 105, a network 110, and a server 115. The user terminal 105 is at least one of a tablet computer, a personal computer, a telephone, a smart phone, a smart television and a laptop. The network 110 is at least one of a mobile network, a WLAN network, a telephone network, and internet. In one embodiment of the present invention, the server 115 comprises a memory unit 120 and a processor 130. The memory unit 120 stores a database 125. The database 125 comprises one or more records associated with at least one tennis, squash and racquetball courts, and a set of program modules. In one embodiment, the one or more records further comprises a list of tennis players using at least one tennis, squash and racquetball courts. The one or more records comprise information regarding location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts. The set of program modules are implemented in a network of Application Specific Integrated Circuit (ASIC) Chipsets in the system. The one or more records comprise information regarding location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts. The processor 130 executes the set of program modules. The set of program modules comprises a display module 135, an input module 140 a booking module 145, a purchaser module 150. The display module 135 presents a user with the list of available time slots. Further, the display module 135 presents the list of available time slots via at least one of an LCD screen and the user terminal 105. The display module 135 further presents the user with the list of tennis players using at least one tennis, squash and racquetball courts.

The input module 140 is configured to receive a request from a user. Further, the input module 140 receives the request via at least one of the user terminal 105 and a telephone (not shown). Moreover, the user terminal 105 is at least one of a smartphone, a laptop, and a personal computer. The request is to reserve at least one of a tennis lesson and a tennis, squash and racquetball courts, in at least one available time slot in the list of available time slots. Furthermore, the input module 140 receives the request as at least one of a voice command, a text command and a gesture based command. The booking module 145 is configured to record the request in the database 125. In one example, the booking module 145 is a booking and purchaser module. The purchaser module 150 is configured to enable the user to purchase one or more club memberships for the at least one tennis, squash and racquetball courts.

Advantageously, the present invention eliminates need for the user to search for services available at the at least one tennis, squash and racquetball courts. In one example, the user is already a member of at least one club using the at least one tennis, squash and racquetball courts. In another example, the user has already acquainted with at least one tennis coach. The present invention enables the user to request for a plurality of services from the at least one tennis coach. The present invention arranges a play time for the user on basis of the plurality of services required by the user. The present invention also considers factors such as court availability, presence of the user's acquaintances on the at least one tennis, squash and racquetball courts. Further, the present invention reminds the user to buy membership to the tennis, squash and racquetball courts and renew membership to the tennis, squash and racquetball courts. Furthermore, the present invention enables the user to play as a guest in the tennis, squash and racquetball courts. The present invention enables the user to book the at least one tennis, squash and racquetball courts from any part of the world 24 hours a day and 7 days a week. The present invention enables the user to perform at least three tasks: Paying for a reservation, Connecting with other tennis players in the at least one tennis, squash and racquetball courts, and Selecting the at least one tennis, squash and racquetball courts for further practice. In one example, the present invention enables setting up of play time and play dates for sports personnel and sports teams by automatically connecting the sports personnel with different sports arenas, sports fields and sports clubs.

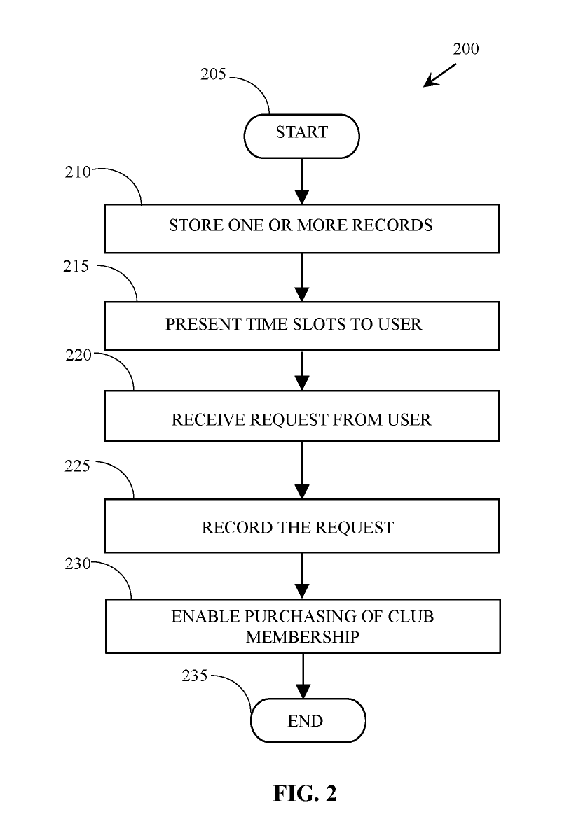

FIG. 2 is a flow chart illustrating a computer-implemented method 200 of implementing a reservation system for tennis, squash and racquetball courts, according to yet another embodiment of the present invention. The method 200 is implemented in an environment. The environment comprises a user terminal, a network and a server. The user terminal is at least one of a tablet computer, a personal computer, a telephone, a smart phone, a smart television and a laptop. The network is at least one of a mobile network, a WLAN network, a telephone network and internet. In one embodiment of the present invention, the server comprises a memory unit and a processor. The memory unit stores a database. The method 200 commences at step 205.

At step 210, the database stores one or more records associated with at least one tennis, squash and racquetball courts, and a set of program modules. In one embodiment, the one or more records further comprises a list of tennis players using at least one tennis, squash and racquetball courts. The one or more records comprise information regarding location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts. The set of program modules are implemented in a network of Application Specific Integrated Circuit (ASIC) Chipsets in the system. The one or more records comprise information regarding location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts. The processor executes the set of program modules. The set of program modules comprises a display module, an input module and a booking module.

At step 215, the display module presents a user with the list of available time slots. Further, the display module presents the list of available time slots via at least one of an LCD screen, an LED screen and a user terminal. The display module further presents the user with the list of tennis players using at least one tennis, squash and racquetball courts.

At step 220, the input module is configured to receive a request from a user. Further, the input module receives the request via at least one of a user terminal and a telephone. Moreover, the user terminal is at least one of a smartphone, a laptop, and a personal computer. The request is to reserve at least one of a tennis lesson and a tennis, squash and racquetball courts, in at least one available time slot in the list of available time slots. Furthermore, the input module receives the request as at least one of a voice command, a text command and a gesture based command.

At step 225, the booking module is configured to record the request in the database.

At step 230, a purchaser module enables the user to purchase one or more club memberships for the at least one tennis, squash and racquetball courts.

The method 200 ends at step 235.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A reservation system for tennis, squash and racquetball courts, the system comprising:
a memory unit to store:
a database comprising one or more records associated with at least one tennis, squash and racquetball courts, and
a set of program modules,
wherein the one or more records comprise information regarding location of at least one tennis, squash and racquetball courts, time and date of bookings of at least one tennis, squash and racquetball courts, a list of available time slots in at least one tennis, squash and racquetball courts, and tennis lessons conducted on at least one tennis, squash and racquetball courts;
a processor to execute the set of program modules, wherein the set of program modules comprise:
an input module, executed by the processor, configured to receive an request from a user, wherein the request is to reserve at least one of a tennis lesson and a tennis, squash and racquetball courts;
a booking module, executed by the processor, configured to record the request in the database; and
a purchaser module, executed by the processor, configured to enable the user to purchase one or more club memberships for the at least one tennis, squash and racquetball courts.

2. The system of claim 1, wherein the one or more records further comprises a list of tennis players using at least one tennis, squash and racquetball courts.

3. The system of claim 1, wherein the input module receives the request via at least one of a user terminal and a telephone.

4. The system of claim 1, wherein the display module present the list of available time slots via at least one of an LCD screen, an LED screen and a user terminal.

5. The system of claim 3, wherein the user terminal is at least one of a smartphone, a laptop, and a personal computer.

6. The system of claim 1, wherein the input module receives the request as at least one of a voice command, a text command and a gesture based command.

7. The system of claim 1, wherein the display module further presents the user with the list of tennis players using at least one tennis, squash and racquetball courts.

8. The system of claim 1, wherein the set of program modules are implemented in a network of Application Specific Integrated Circuit (ASIC) Chipsets in the system.

9. A computer implemented method of implementing a reservation system for tennis, squash and racquetball courts, the method comprising:
storing in a memory unit, one or more records associated with at least one tennis, squash and racquetball courts, wherein the one or more records comprises information regarding location of at least one tennis, squash and racquetball courts, time and date of bookings of at least one tennis, squash and racquetball courts, a list of available time slots in at least one tennis, squash and racquetball courts, and tennis lessons conducted on the tennis, squash and racquetball courts;
presenting by a processor, via a display module a user with the list of available time slots;
receiving by the processor, via an input module, a request from a user, wherein the request is to reserve at least one of a tennis lesson and a tennis, squash and racquetball courts, in at least one available time slot; and
recording by the processor, via a booking module, the request in the database; and
enabling the user, by the processor via a purchaser module, to purchase one or more club memberships for the at least one tennis, squash and racquetball courts.

10. The method of claim 9, wherein the one or more records further comprises a list of tennis players using at least one tennis, squash and racquetball courts.

11. The method of claim 9, wherein the input module receives the request via at least one of a user terminal and a telephone.

12. The method of claim 9, wherein the display module present the list of available time slots via at least one of an LCD screen, an LED screen and a user terminal.

13. The method of claim 11, wherein the user terminal is at least one of a smartphone, a laptop, and a personal computer.

14. The method of claim 9, wherein the input module receives the request as at least one of a voice command, a text command and a gesture based command.

15. The method of claim 9, wherein the display module further presents the user with the list of tennis players using at least one tennis, squash and racquetball courts.

16. The method of claim 9, wherein the set of program modules are implemented in a network of Application Specific Integrated Circuit (ASIC) Chipsets in the system.
